(19) United States
(12) Patent Application Publication
(10) Pub. No.: US 2011/0054184 A1
(43) Pub. Date: Mar. 3, 2011

(54) SURFACE TREATMENT AGENT AND SURFACE TREATMENT METHOD

(75) Inventors: Masaaki Yoshida, Kawasaki-shi (JP); Mai Sugawara, Kawasaki-shi (JP); Jun Koshiyama, Kawasaki-shi (JP)

(73) Assignee: TOKYO OHKA KOGYO CO., LTD., Kawasaki-shi (JP)

(21) Appl. No.: 12/870,439

(22) Filed: Aug. 27, 2010

(30) Foreign Application Priority Data
Aug. 28, 2009 (JP) 2009-198382

(51) Int. Cl. C07F 7/00; C09K 3/00

(52) U.S. Cl. 548/110; 252/182.3

(57) ABSTRACT

The object is to provide a surface treatment agent that can effectively prevent pattern collapse of an inorganic pattern or resin pattern provided on a substrate, and a surface treatment method using such a surface treatment agent. In addition, as another object, the present invention has an object of providing a surface treatment agent that can carry out silylation treatment to a high degree on the surface of a substrate, and a surface treatment method using such a surface treatment agent. The surface treatment agent used in the surface treatment of a substrate contains a silylation agent and a silylated heterocyclic compound.

This application is based on and claims the benefit of priority from Japanese Patent Application No. 2009-198382, filed on 28 Aug. 2009, the content of which is incorporated herein by reference.

### BACKGROUND OF THE INVENTION

1. Field of the Invention

The present invention relates to a surface treatment agent and a surface treatment method, and particularly relates to a surface treatment agent and surface treatment method of a substrate to be used in semiconductor integrated-circuit production.

2. Related Art

In the production of semiconductor devices and the like, lithography technology is applied prior to conducting processing such as etching on a substrate. With this lithography technology, a photosensitive resin composition is used to provide a photosensitive resin layer on the substrate, then this is selectively irradiated and exposed by actinic radiation, and after a developing process has been performed, the photosensitive resin layer is selectively dissolved and removed to form a resin pattern on the substrate. Then, an inorganic pattern is formed on the substrate by performing an etching process with this resin pattern as a mask.

Incidentally, in recent years, trends in higher integration and miniaturization of semiconductor devices have grown, and thus progress towards miniaturization and higher aspect ratios of the inorganic pattern manufactured using a resin pattern as a mask and etching processes has advanced. However, a problem has arisen of so-called pattern collapse in the meantime. This pattern collapse is a phenomenon when forming several resin patterns and inorganic patterns on a substrate in parallel, in which adjacent patterns close in so as to lean on one another, and depending on the situation, the pattern become damaged and separate from the base. If such pattern collapse occurs, the desired product will not be obtained, thereby causing a decline in the yield and reliability of the product.

This pattern collapse is known to occur when drying a cleaning liquid in a cleaning process after pattern formation, due to the surface tension of this cleaning liquid. In fact, when the cleaning liquid is removed in a drying step, stress based on the surface tension of the cleaning liquid acts between patterns, whereby pattern collapse occurs.

Consequently, there have been numerous experiments thus far to prevent pattern collapse by adding a substance to the cleaning liquid that causes the surface tension to decrease. For example, a cleaning liquid to which isopropyl alcohol, a cleaning liquid to which a fluorine-based surfactant, and the like have been proposed (for example, refer to Patent Documents 1 and 2).

In addition, although not the same as pattern collapse, in order to improve adhesion between the resin pattern, which is the mask, and the surface of the substrate to prevent a partial loss of the resin pattern by a chemical developing solution, hydrophobization treatment (silylation treatment) has been being performed on the surface of substrates using hexamethyldisilazane (HMDS) (for example, refer to “Background of the Invention” of Patent Document 3).

### Prior Art Documents

### Patent Documents

Patent Document 1: Japanese Unexamined Patent Application Publication No. H6-163391

Patent Document 2: Japanese Unexamined Patent Application Publication No. H7-142349

Patent Document 3: Japanese Unexamined Patent Application Publication No. H11-511900

### SUMMARY OF THE INVENTION

However, with the cleaning liquid schemes described in Patent Documents 1 and 2, there has been a problem in that prevention of pattern collapse is insufficient. In addition, in a case of conducting silylation treatment on the surface of a substrate using HMDS, time may be required in the silylation treatment and the desired effects may not be obtained due to the silylation treatment of the surface of the substrate not being sufficient.

The present invention was made taking into account the above situation, and has an object of providing a surface treatment agent that can effectively prevent pattern collapse of an inorganic pattern or resin pattern provided on a substrate, and a surface treatment method using such a surface treatment agent. In addition, as another object, the present invention has an object of providing a surface treatment agent that can carry out silylation treatment to a high degree, and a surface treatment method using such a surface treatment agent.

In order to solve the abovementioned problems, the present inventors have conducted extensive studies. As a result thereof, they have found that, when performing surface treatment on a surface of a substrate using a surface treatment agent containing a silylation agent and a silylated heterocyclic compound, the surface of the substrate is highly hydrophobized. In addition, they have found that, by hydrophobizing the surface of an inorganic pattern or resin pattern provided on a substrate to by treating with such a surface treatment agent to increase the contact angle thereof to a cleaning liquid, pattern collapse of an inorganic pattern or resin pattern is prevented, thereby arriving at completion of the present invention. More specifically, the present invention provides the following.

According to a first aspect of the present invention, a surface treatment agent used in surface treatment of a substrate includes a silylation agent and a silylated heterocyclic compound.

According to a second aspect of the present invention, a surface treatment method includes exposing a surface of a substrate to the surface treatment agent according to the first aspect of the present invention, and treating the surface of the substrate.

According to the present invention, provided are a surface treatment agent that can effectively prevent pattern collapse of an inorganic pattern or resin pattern provided on a substrate, and a surface treatment method using such a surface treatment. In addition, according to the present invention, provided are a surface treatment agent that can carry out silylation treatment to a high degree on the surface of a substrate, and a surface treatment method using such a surface treatment agent.

### DETAILED DESCRIPTION OF THE INVENTION

### Surface Treatment Agent

First, a surface treatment agent of the present invention will be explained. The surface treatment agent of the present invention is ideally used when silylating a surface of a substrate. Herein, a substrate used for semiconductor devise manufacturing is exemplified as the “substrate”, which is the target of silylation treatment, the “surface of the substrate” is exemplified by the surface of the substrate itself, as well as the surfaces of the inorganic pattern and resin pattern provided on the substrate, and the surfaces of the inorganic layer and organic layer that have not been patterned.

As the inorganic pattern provided on the substrate, a pattern is exemplified that has been formed by producing an etching mask on the surface of an inorganic layer present on the substrate by way of a photoresist method, and subsequently performing an etching process. As the inorganic layer, other than the substrate itself, an oxide film of an element constituting the substrate, and a film, layer, etc. of an inorganic matter such as silicon nitride, titanium nitride, and tungsten formed on the surface of the substrate are exemplified. Although such a film or layer is not particularly limited, a film, layer, etc. that is formed in the manufacturing process of the semiconductor device is exemplified.

As the resin pattern provided on the substrate, a resin pattern formed on the substrate by a photoresist method is exemplified. Such a resin pattern, for example, is formed by forming an organic layer, which is a film of photoresist, on the substrate, exposing this organic layer through a photomask, and developing. As the organic layer, other than the surface of the substrate itself, a layer that is provided on the surface of a laminated film provided on the surface of the substrate is exemplified. Although such an organic layer is not particularly limited, a film of an organic matter provided in order to form an etching mask in the manufacturing process of a semiconductor device is exemplified.

Since the surface treatment agent of the present invention is vaporized by a means such as heating and bubbling, surface treatment may be performed by causing the vaporized surface treatment agent to contact the surface of a substrate, and surface treatment may be performed by coating a surface treatment agent of solution type to which a solvent has been added on the surface of the substrate by a means such as a spin-coating method or dipping method, for example.

The surface treatment agent of the present invention contains a silylation agent and a silylated heterocyclic compound. Each component thereof will be explained hereinafter.

### Silylation Agent

First, a silylation agent used in the surface treatment agent of the present invention will be explained. The silylation agent used in the surface treatment agent of the present invention is a component for silylating the surface of a substrate, and increasing the hydrophobicity of the surface of the substrate.

The silylation agent contained in the surface treatment agent of the present invention is not particularly limited, and any conventional well-known silylation agent can be used. As such a silylation agent, for example, a silylation agent having a substituent represented by the following general formula (2) can be used.

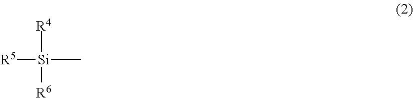

In the above general formula (2), R⁴, R⁵ and R⁶ each independently represents a hydrogen atom, halogen atom, nitrogen-containing group, or organic group, and the total number of carbon atoms contained in R⁴, R⁵ and R⁶ is at least 1.

More specifically, as the silylation agent having a substituent represented by the above general formula (2), a silylation agent represented by the following general formulas (3) to (9) can be used.

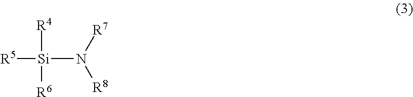

In the above general formula (3), R⁴, R⁵, and R⁶ are the same as in the above general formula (2), R⁷ represents a hydrogen atom or a saturated or unsaturated alkyl group, and R⁸ represents a hydrogen atom, saturated or unsaturated alkyl group, acetyl group, or saturated or unsaturated hetero-cycloalkyl group. R⁷ and R⁸ may bond together to form a saturated or unsaturated hetero-cycloalkyl group having a nitrogen atom.

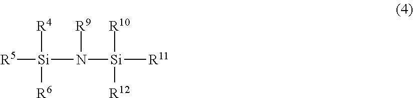

In the above general formula (4), R⁴, R⁵ and R⁶ are the same as in the above general formula (2), R⁹ represents a hydrogen atom, methyl group, trimethylsilyl group, or dimethylsilyl group, R¹⁰, R¹¹ and R¹² each independently represent a hydrogen atom or organic group, and the total number of carbon atoms contained in R¹⁰, R¹¹ and R¹² is at least 1.

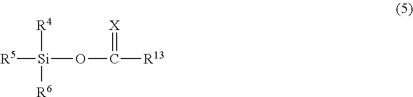

In the above general formula (5), R⁴, R⁵ and R⁶ are the same as in the above general formula (2), X represents O, CHR¹⁴, CHOR¹⁴, CR¹⁴R¹⁴, or NR¹⁵, R¹³ and R¹⁴ each independently represent a hydrogen atom, saturated or unsaturated alkyl group, saturated or unsaturated cycloalkyl group, trialkylsilyl group, trialkylsiloxy group, alkoxy group, phenyl group, phenylethyl group, or acetyl group, and R¹⁵ represents a hydrogen atom, alkyl group, or trialkylsilyl group.

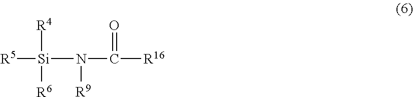

In the above general formula (6), R⁴, R⁵ and R⁶ are the same as in the above general formula (2), R⁹ is the same as in the above general formula (4), and R¹⁶ represents a hydrogen atom, saturated or unsaturated alkyl group, trifluoromethyl group, or trialkylsilyl amino group.

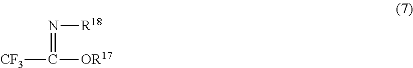

In the above general formula (7), R¹⁷ and R¹⁸ each independently represent a hydrogen atom, alkyl group, or trialkylsilyl group, and at least one of R¹⁷ and R¹⁸ represents a trialkylsilyl group.

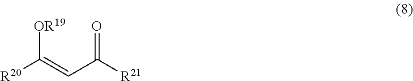

In the above general formula (8), R¹⁹ represents a trialkylsilyl group, and R²⁰ and R²¹ each independently represent a hydrogen atom or organic group.

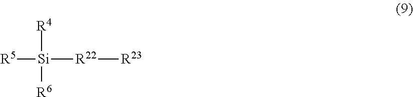

In the above general formula (9), R⁴, R⁵ and R⁶ are the same as in the above general formula (2), R²² represents an organic group, and R²³ is not present or represents —SiR²⁴R²⁵R²⁶ if present. R²⁴, R²⁵ and R²⁶ each independently represent a hydrogen atom, halogen atom, nitrogen-containing group or organic group, and any one of R²⁴, R²⁵ and R²⁶ may bond with any one of R⁴, R⁵ and R⁶ through a nitrogen atom to form an imino group.

As the silylation agent represented by the above general formula (3), (N,N-dimethylamino)trimethylsilane, (N,N-dimethylamino)dimethylsilane, (N,N-dimethylamino)monomethylsilane, (N,N-diethylamino)trimethylsilane, tert-butylaminotrimethylsilane, (alylamino)trimethylsilane, (trimethylsilyl)acetamide, (N—N-dimethylamino)dimethylvinylsilane, (N,N-dimethylamino)dimethlypropylsilane, (N,N-dimethylamino)dimethyloctylsilane, (N,N-dimethylamino)dimethylphenylethylsilane, (N,N-dimethylamino)dimethylphenylsilane, (N,N-dimethlyamino)dimethyl-tert-butylsilane, (N,N-dimethylamino)triethylsilane, trimethylsilanamine, and the like are exemplified.

As the silylation agent represented by the above general formula (4), hexamethyl disilazane, N-methyl-hexamethyl disilazane, 1,1,3,3-tetramethyl disilazane, 1,3-dimethyl disilazane, 1,2-di-N-octyltetramethyl disilazane, 1,2-divinyltetramethyl disilazane, heptamethyl disilazane, nonamethyl trisilazane, tris(dimethylsilyl)amino, tris(trimethylsilyl)amino, pentamethylethyl disilazane, pentamethylvinyl disilazane, pentamethylpropyl disilazane, pentamethylphenylethyl, disilazane, pentamethyl-tert-butyl disilazane, pentamethylphenyl disilazane, trimethyltriethyl disilazane and the like are exemplified.

As the silylation agent represented by the above general formula (5), trimethylsilyl acetate, dimethylsilyl acetate, monomethylsilyl acetate, trimethylsilyl propionate, trimethylsilyl butyrate, trimethylsilyloxy-3-pentene-2-one and the like are exemplified.

As the silylation agent represented by the above general formula (6), bis(trimethylsilyl)urea, N-trimethylsilyl acetamide, N-methyl-N-(trimethylsilyl)trifluoroacetamide and the like are exemplified.

As compounds represented by the above general formula (7), bis(trimethylsilyl)trifluoroacetamide and the like are given, and as the compound represented by the above general formula (8), 2-trimethylsiloxypenta-2-en-4-one and the like are given. As compounds represented by the above general formula (9), 1,2-bis(chlorodimethylsilyl)ethane, tert-butyldimethylsilyl chloride, 2,2,5,5-tetramethyl-2,5-disila-1-azacyclopentane and the like are given.

Herein, if focusing on a substituent bonding to a silicon atom, it is preferable to use a silylation agent in which a so-called bulky substituent having a large number of carbon atoms contained in the substituent bonds to the silicon atom. By the surface treatment agent containing such a silylation agent, the hydrophobicity of the surface of the substrate that has received treatment by this surface treatment agent can be increased. This can improve the adhesion between the surface of the substrate that has received treatment and the resin pattern. In addition, as will be explained later, among the surfaces of the substrate that have received treatment, pattern collapse of an inorganic pattern or resin pattern can be prevented by increasing the hydrophobicity of the surface of the inorganic pattern and resin pattern in particular.

As a result, in the above general formula (2), the total number of carbon atoms contained in R⁴, R⁵ and R⁶ is preferably at least 4. Above all, from the viewpoint of obtaining sufficient reactivity in the silylation reaction, it is preferable for any one of R⁴, R⁵ and R⁶ in the above general formula (2) to be an organic group having at least 2 carbon atoms (hereinafter referred to as “specific organic group” in this paragraph), and the remaining two to each independently be a methyl group or ethyl group. As the specific organic group, an alkyl group having 2 to 20 carbon atoms that may have a branch and/or substituent, a vinyl group that may have a substituent, an aryl group that may have a substituent, and the like are exemplified. The number of carbon atoms of the specific organic group is preferably 2 to 12, more preferably 2 to 10, and particularly preferably 2 to 8.

From such a viewpoint, among the silylation agents exemplified above, (N-N-dimethylamino) dimethylvinylsilane, (N,N-dimethlyamino)dimethlypropylsilane, (N,N-dimethlyamino)dimethyloctylesilane, (N,N-dimethlyamino)dimethylphenylethylsilane, (N,N-dimethylamno)dimethylphenylsilane, (N,N-dimethylamino)dimethyl-tert-butylsilane, (N,N-dimethylamino)triethylsilane, pentamethylethyl disilazane, pentalmethylvinyl disilazane, pentamethylpropyl disilazane, pentamethylphenylethyl disilazane, pentamthyl-tert-butyl disilazane, pentamethylphenyl disilazane, trimethyltriethyl disilazane and the like are preferably exemplified.

The silylation agents exemplified above can be used individually or by mixing at least 2 thereof.

### Silylated Heterocyclic Compound

Next, the silylated heterocyclic compound used in the surface treatment agent of the present invention will be explained. The silylated heterocyclic compound used in the surface treatment agent of the present invention has an action of promoting silylation of the surface of the substrate by the above-mentioned silylation agent by way of catalytic action, and is added in order to highly hydrophobize the surface of the substrate.

Thus far, silylation of the surface of a substrate has commonly been performed in a case of setting hexamethyldisilazane (HMDS) as the silylation agent, for example, by causing vapor of HMDS to contact the surface of the substrate, and causing a surface treatment liquid containing HMDS to contact the surface of the substrate. However, because of the lack of reactivity of the silylation agent, a long time may have been required in the silylation reaction, and sufficient hydrophobicity of the surface of the substrate may not have been obtained. Such a case may lead to there being a bottleneck in the manufacturing process of the semiconductor device, and the adhesion of the etching mask to the surface of the substrate (resin pattern) or the like being insufficient. The present invention was accomplished based on the knowledge that, by having a silylation agent and a silylated heterocyclic compound contained in a surface treatment agent, the silylation reaction by the silylation agent is promoted by way of the catalytic action of the silylated heterocyclic compound, and the surface of the substrate is thus highly hydrophobized. As a result, if silylation treatment is performed on the surface of a substrate using the surface treatment agent of the present invention, the surface of the substrate can be highly hydrophobized. In addition, with using the surface treatment agent of the present invention, when performing hydrophobization to a similar extent as has been done thus far on the surface of a substrate, the time required for surface treatment can be shortened.

The silylated heterocyclic compound used in the surface treatment agent of the present invention is a compound having a structure in which a heterocyclic group is bonded to a silyl group. A compound such as of the following general formula (1) is exemplified as such a compound.

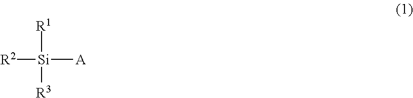

In the above general formula (1), R¹, R² and R³ each independently represent a hydrogen atom or organic group, and at least one among R¹, R² and R³ represents an organic group. A represents a heterocyclic group and may have a substituent.

The silylated heterocyclic group is preferably a silylated nitrogen-containing heterocyclic compound in which A in the above general formula (1) has a nitrogen atom. In addition, the silylated heterocyclic compound is preferably a compound in which A in the above general formula (1) has aromaticity. By A in the above general formula (1) having aromaticity, it is possible to make the hydrophobicity of the surface of the substrate treated by the surface treatment agent to be high.

In addition, the silylated heterocyclic compound having A in the above general formula (1) that is aromatic and having a nitrogen atom is particularly preferable from the viewpoint of being able to impart great hydrophobicity to the surface of the substrate and accessibility. As such a silylated heterocyclic compound, a silylated imidazole compound and silylated triazole compound are exemplified.

As the silylated heterocyclic compound used in the surface treatment agent of the present invention, monomethylsilyl imidazole, dimethylsilyl imidazole, trimethylsilyl imidazole, monomethylsilyl triazole, dimethylsilyl triazole, trimethylsilyl triazole and the like are exemplified. These silylated heterocyclic compounds can be used individually or by mixing at least two thereof.

The added amount of the silylated heterocyclic compound in the surface treatment agent is preferably 0.001 to 50% by mole relative to the moles of the above-mentioned silylation agent, is more preferably 0.01 to 20% by mole, and is most preferably 0.1 to 10% by mole. By the added amount of the silylated heterocyclic compound being at least 0.001% by mole relative to the moles of the silylation agent, the silylation reaction is promoted by the surface treatment agent, and thus the hydrophobicity of the surface of the substrate, which is the treatment target, can be improved. It should be noted that, since the silylated heterocyclic compound has high reaction activity compared to silylation agents such as HMDS, the added amount thereof is preferably no more than 50% by mole relative to the moles of silylation agent from the viewpoint of temporal stability and quality control. In addition, for the above such reason, the surface treatment agent of the present invention is made in a state not containing the silylated heterocyclic compound for storage and transport, and the silylated heterocyclic compound is preferably added immediately before use thereof. Also from this viewpoint, the added amount of the silylated heterocyclic compound is preferably no more than 50% by mole relative to the moles of the silylation agent for convenience upon use.

### Solvent

The surface treatment agent of the present invention may contain a solvent. Surface treatment of the substrate by way of a spin-coating method, immersion method, or the like becomes easy by the surface treatment agent of the present invention containing a solvent. Next, the solvents that can be contained in the surface treatment agent of the present invention will be explained.

So long as being able to dissolve the silylation agent and the silylated heterocyclic compound and causing little damage to the surface of the substrate (inorganic pattern, resin pattern, etc.), a convention well-known solvent can be used as the solvent without being particularly limited.

More specifically, sulfoxides such as dimethylsulfoxide; sulfones such as dimethylsulfone, diethylsulfone, bis(2-hydroxyethyl)sulfone and tetramethylenesulfone; amides such as N,N-dimethylformamide, N-methylformamide, N,N-dimethylacetamide, N-methylacetamide and N,N-dimethylacetamide; lactams such as N-methyl-2-pyrrolidone, N-ethyl-2-pyrrolidone, N-propyl-2-pyrrolidone, N-hydroxymethyl-2-pyrrolidone and N-hydroxyethyl-2-pyrrolidone. imidazolidinones such as 1,3-dimethyl-2-imidazolidinone, 1,3-diethyl-2-imidazolidinone and 1,3-diisopropyl-2-imidazolidinone; dialkyl glycol ethers such as dimethyl glycol, dimethyl diglycol, dimethyl trigylcol, methylethyl diglycol and diethyl glycol; (poly)alkylene glycol monoalkyl ethers such as ethylene glycol monomethyl ether, ethylene glycol monoethyl ether, ethylene glycol mono-n-propyl ether, ethylene glycol mono-n-butyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, propylene glycol mono-n-propyl ether, propylene glycol mono-n-butyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether and tripropylene glycol monoethyl ether; (poly)alkylene glycol monoalkyl ether acetates such as ethylene glycol monomethyl ether acetate, ethylene glycol monoethyl ether acetate, diethylene glycol monomethyl ether acetate, diethylene glycol monoethyl ether acetate, propylene glycol monomethyl ether acetate and propylene glycol monoethyl ether acetate; other ethers such as dimethyl ether, diethyl ether, methylethyl ether, dipropyl ether, diisopropyl ether, dibutyl ether, diisoamyl ether, diethylene glycol dimethyl ether, diethylene glycol methylethyl ether, diethylene glycol diethyl ether and tetrahydrofuran; ketones such as methyl ethyl ketone, cyclohexanone, 2-heptanone and 3-heptanone; alkyl lactate esters such as 2-hydroxypropanoic acid methyl and 2-hydroxypropanoic acid ethyl; other esters such as 2-hydroxy-2-methylpropanoic acid ethyl, 3-methoxypropanoic acid methyl, 3-methoxypropanoic acid ethyl, 3-ethoxypropanoic acid methyl, 3-ethoxypropanoic acid ethyl, ethoxyacetic acid ethyl, hydroxyacetic acid ethyl, 2-hydroxy-3-methylbutanoic acid methyl, 3-methyl-3-methoxybutyl acetate, 3-methyl-3-methoxybutyl propionate, ethyl acetate, n-propyl acetate, i-propyl acetate, n-butyl acetate, i-butyl acetate, n-pentyl formate, i-pentyl acetate, n-butyl propionate, ethyl butyrate, n-propyl butyrate, i-propyl butyrate, n-butyl butyrate, methyl pyruvate, ethyl pyruvate, n-propyl pyruvate, methyl acetoacetate, ethyl acetoacetate and ethyl 2-oxobutanoate; lactones such as β-propiolactone, γ-butyrolactone and δ-pentyrolactone; terpenes such as p-menthane, diphenyl methane, limonene, terpinene, bornane, norbornane and pinane; and the like can be exemplified. These solvents can be used individually or by mixing at least two thereof.

It should be noted that, depending on the type of silylated heterocyclic compound contained in the surface treatment agent of the present invention, a crystalline heterocyclic compound such as imidazole and triazole may be liberated, for example, when deactivating the catalytic action. At this time, if the solubility of the heterocyclic compound thus liberated in the solvent contained in the surface treatment agent is low, the heterocyclic compound thus liberated will precipitate, and may adversely affect the manufacturing process of the semiconductor device. From this viewpoint, it is preferable to use a polar solvent in which the heterocyclic compound shows favorable solubility. In a case in which it is necessary to use a non-polar solvent in the surface treatment agent of the present invention because of the relationship with a subsequent step of the surface treatment by the surface treatment agent of the present invention, after having performed the surface treatment using the surface treatment agent of the present invention, it is preferable to provide a step to remove crystals of the heterocyclic compound that have precipitated, as necessary.

In addition, in a case in which the treatment target by the surface treatment agent of the present invention is an organic material such as a resin pattern, an ether-based solvent having 2 to 14 carbon atoms is preferably used, and an ether-based solvent having 3 to 12 carbon atoms is more preferably used, from the viewpoint of being able to reduce the damage to the treatment target. More specifically, an alkyl ether such as dimethyl ether, diethyl ether, methylethyl ether, dipropyl ether, diisopropyl ether, dibutyl ether and diisoamyl ether can be exemplified as such an ether-based solvent. Among these, diisopropyl ether, dibutyl ether and diisoamyl ether are preferred. The above-mentioned ether-based solvents can be used individually or by combining at least two thereof.

In a case of having a solvent contained in the surface treatment agent of the present invention, the total concentration of the silylation agent and the silylated heterocyclic compound contained in the surface treatment agent is preferably at least 0.1% by mass for practical use.

### Surface Treatment Method

Next, a surface treatment method of the present invention will be explained.

The surface treatment method of the present invention exposes the surface of a substrate to the above-mentioned surface treatment agent of the present invention, and treats the surface of the substrate.

As has been explained, the surface of the substrate, which is the treatment target of the surface treatment method of the present invention, indicates the surface of the substrate itself, the surface of an inorganic pattern and resin pattern and an inorganic layer and organic layer that is not patterned, provided on the substrate. Since explanations for the surface of the inorganic pattern and resin pattern and the inorganic layer and organic layer, which are not patterned, provided on the substrate are as mentioned earlier, the explanations are omitted here.

The surface treatment method of the present invention performs silylation treatment on the surface of a substrate, and the object of this treatment may be anything; however, as a representative example of the object of this treatment, (1) to improve the adhesion to a resin pattern composed of photoresist or the like, and (2) to prevent pattern collapse of an inorganic pattern or resin pattern on the surface of a substrate during cleaning of the surface of the substrate can be given.

For the above-mentioned (1), prior to a step of forming an organic layer, which is a film of photoresist, for example, the surface of the substrate may be exposed to the above-mentioned surface treatment agent of the present invention. As a method of exposing the surface of the substrate to the above-mentioned surface treatment agent of the present invention, a convention well-known method can be used without being particularly limited and, for example, a method of vaporizing the above-mentioned surface treatment agent of the present invention to form vapor and causing this vapor to contact the surface of the substrate, a method of causing the above-mentioned surface treatment agent of the present invention to contact the surface of the substrate by a spin-coating method, immersion method, etc. can be exemplified. By such an operation, the surface of the substrate is silylated, and the hydrophobicity of the surface of the substrate is improved; therefore, the adhesion to the photoresist or the like is improved, for example.

For the above-mentioned (2), prior to performing a cleaning operation after an inorganic pattern or resin pattern has been formed, the surface of the substrate may be exposed to the above-mentioned surface treatment agent of the present invention. Next, the reason that pattern collapse of an inorganic pattern or resin pattern on the surface of a substrate can be prevented during cleaning of the surface of the substrate by conducting such a surface treatment will be explained.

Usually, after an inorganic pattern has been formed on the surface of a substrate, the surface of the pattern is generally cleaned using a cleaning liquid such as SPM (sulfuric acid/hydrogen peroxide solution) and APM (ammonia/hydrogen peroxide solution). In addition, after a resin pattern has been formed on the surface of a substrate, developing residue and adhered developing solution are generally cleaned and removed using a cleaning liquid such as water and an activator rinse.

In the surface treatment method of the present invention, prior to cleaning such an inorganic pattern or resin pattern, the pattern surface is treated with the above-mentioned surface treatment agent, and the surface of the pattern is hydrophobized.

Herein, the force F acting between the patterns of the inorganic pattern and resin pattern during cleaning is represented as in the following formula (I). In the formula, γ represents the surface tension of the cleaning liquid, θ presents the contact angle of the cleaning liquid, A represents the aspect ratio of the pattern, and D represents the distance between the pattern side walls.

F=2γ·cos θ·A/D (I)

Therefore, if the surface of the pattern can hydrophobized and the contact angle of the cleaning liquid increased (cosh reduced), the force acting between the patterns during the following cleaning can be reduced, and thus pattern collapse can be prevented.

This surface treatment is performed by immersing the substrate on which an inorganic pattern or resin pattern has been formed in the surface treatment agent, or by coating or spraying the surface treatment agent on the inorganic pattern or resin pattern. The treatment time is preferably 1 to 60 seconds. In addition, after this surface treatment, the contact angle of water on the pattern surface preferably becomes 40 to 120 degrees, and more preferably becomes 60 to 100 degrees.

When the above surface treatment has finished, the inorganic pattern or resin pattern is cleaned. In this cleaning process, cleaning liquids that have been conventionally used in cleaning processes of inorganic patterns and resin patterns can be applied without modification in this cleaning process. For example, SPM, APM, and the like can be exemplified for the inorganic pattern, and water, surfactant containing cleaning liquid, and the like can be exemplified for the resin pattern.

It should be noted that the surface treatment and cleaning process are preferably continuous processes from the viewpoint of throughput. As a result, it is preferable to select a liquid that excels in displaceability with the cleaning liquid as the surface treatment liquid.

The surface treatment agent used in the surface treatment method of the present invention contains a silylation agent and silylated heterocyclic compound as mentioned for the above-mentioned surface treatment agent of the present invention, and this silylated heterocyclic compound is a compound that functions as a catalyst when silylating the surface of the substrate. As a result, the surface of the substrate treated by the surface treatment method of the present invention is highly hydrophobized (silylated), and leads to improving the adhesion to the resin pattern or the like and preventing pattern collapse.

It should be noted that the silylated heterocyclic compound used in this surface treatment agent is a compound that is subject to degradation from the presence of moisture in the air or the like; therefore, for the solution containing the silylated heterocyclic compound, advanced control is necessary so as not to come into contact with moisture in the air, for example. As a result, in the surface treatment method of the present invention, this surface treatment agent is made as a two-part liquid surface treatment agent, in which the silylation agent is contained in one of the solutions, while the silylated heterocyclic compound is contained in the other solution, and these are preferably constituted to be mixed immediately before use. It is preferred from the viewpoint of a reduction in the control cost because of the amount of the solution containing the silylated heterocyclic compound requiring advanced control can be reduced by making such a constitution.

### Examples

Although the present invention will be explained more specifically by way of Examples hereinafter, the present invention is not to be limited to the following Examples. Preparation of Surface Treatment Agent (Examples 1 to 11 and Comparative Examples 1 to 7)

The surface treatment agents of Examples 1 to 11 were produced by adding trimethylsilyl imidazole or trimethylsilyl triazole as the silylated heterocyclic compound to every silylation agent (A to I) listed in Table 1 in an amount equivalent to 5% by volume of the silylation agent, and then mixing by stirring. In addition, the mixtures of every silylation agent (A to G) were set as the surface treatment agent of Comparative Examples 1 to 7, respectively. In Table 1, the chemical formulas of the silylation agents represented by A to I are as follows. It should be noted that “Et” in the following chemical formula indicates an ethyl group.

TABLE 1
(A)

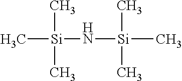

(B)

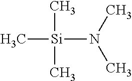

(C)

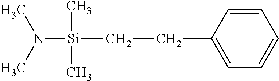

(D)

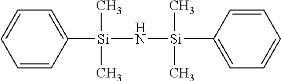

(E)

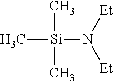

(F)

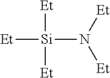

(G)

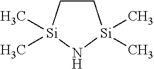

(H)

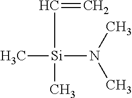

(I)

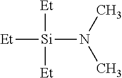

| | Silylation | Silylated Heterocyclic | Contact angle |
|---|---|---|---|
| | agent | Compound | (degrees) |
| Example 1 | A | Trimethylsilyl imidazole | 91 |
| Example 2 | B | Trimethylsilyl imidazole | 91 |
| Example 3 | C | Trimethylsilyl imidazole | 87 |
| Example 4 | D | Trimethylsilyl imidazole | 93 |
| Example 5 | E | Trimethylsilyl imidazole | 88 |
| Example 6 | F | Trimethylsilyl imidazole | 89 |
| Example 7 | G | Trimethylsilyl imidazole | 98 |
| Example 8 | H | Trimethylsilyl imidazole | 97 |
| Example 9 | I | Trimethylsilyl imidazole | 96 |
| Example 10 | A | Trimethylsilyl triazole | 89 |
| Example 11 | H | Trimethylsilyl triazole | 94 |
| Comparative | A | — | 53 |
| Example 1 | | | |
| Comparative | B | — | 84 |
| Example 2 | | | |
| Comparative | C | — | 78 |
| Example 3 | | | |
| Comparative | D | — | 65 |
| Example 4 | | | |
| Comparative | E | — | 70 |
| Example 5 | | | |
| Comparative | F | — | 46 |
| Example 6 | | | |
| Comparative | G | — | 76 |
| Example 7 | | | |
| Comparison | — | — | 2 |

### Confirmation of Hydrophobization Results

After a silicon wafer had been immersed for 30 seconds at room temperature in the surface treatment agents of Examples 1 to 11 and Comparative Examples 1 to 7, the surface of this silicon wafer was cleaned with methyl ethyl ketone, and was made to dry by flowing nitrogen. Then, using a Dropmaster 700 (Kyowa Interface Science Co., Ltd.), a droplet of pure water (1.8 μL) was dropped on the surface of this silicon wafer, and the contact angle was measured 10 seconds after dropping. The results are shown in Table 1. It should be noted that the contact angle listed in Table 1 as “comparison” is a numerical value of a contact angle on a silicon wafer surface to which the surface treatment with the surface treatment agent had not been conducted.

### Preparation of Surface Treatment Agent (Examples 12 to 16 and Comparative Examples 8 to 12)

The surface treatment agents of Examples 12 to 16 were made by setting mixtures in which HMDS (compound of the above-mentioned chemical formula A) and any compound of the following chemical formulas J to N had been mixed in a volume ratio of 9:1 as silylation agents, adding trimethylsilyl imidazole as the silylated heterocyclic compound to this silylation agent in an amount equivalent to 5% by volume of this silylation agent, and then mixing by stirring. In addition, mixtures in which HMDS and any compound of the following chemical formulas J to N had been mixed in a volume ratio 9:1 were set as silylation agents, and the mixtures of these silylation agents were set as the silylation agents of Comparative Examples 8 to 12, respectively. The silylation agents used in each of Examples 12 to 16 and Comparative Examples 8 to 12 are as shown in Table 2.

TABLE 2
(J)

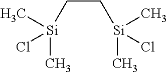

(K)

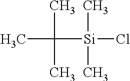

(L)

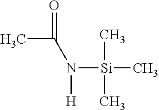

(M)

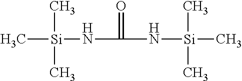

(N)

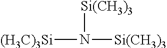

| | | | Contact angle | |
|---|---|---|---|---|
| | Silylation agent | Silylated Heterocyclic | (degrees) | |
| | (volume ratio) | Compound | SiN | Si |
| Example 12 | HMDS:J = 9:1 | Trimethylsilyl imidazole | 97 | 96 |
| Example 13 | HMDS:K = 9:1 | Trimethylsilyl imidazole | 95 | 94 |
| Example 14 | HMDS:L = 9:1 | Trimethylsilyl imidazole | 95 | 91 |
| Example 15 | HMDS:M = 9:1 | Trimethylsilyl imidazole | 96 | 94 |
| Example 16 | HMDS:N = 9:1 | Trimethylsilyl imidazole | 96 | 93 |
| Comparative | HMDS:J = 9:1 | — | 85 | 81 |
| Example 8 | | | | |
| Comparative | HMDS:K = 9:1 | — | 83 | 81 |
| Example 9 | | | | |
| Comparative | HMDS:L = 9:1 | — | 70 | 61 |
| Example 10 | | | | |
| Comparative | HMDS:M = 9:1 | — | 69 | 66 |
| Example 11 | | | | |
| Comparative | HMDS:N = 9:1 | — | 63 | 60 |
| Example 12 | | | | |

### Confirmation of Hydrophobization Results

After a silicon wafer or SiN wafer had been immersed for 30 seconds at room temperature in the surface treatment agents of Examples 12 to 16 and Comparative Examples 8 to 12, the surface of this wafer was cleaned with methyl ethyl ketone, and made to dry by flowing nitrogen. Then, using a Dropmaster 700 (Kyowa Interface Science Co., Ltd.), a droplet of pure water (1.8 μL) was dropped on the surface of this silicon wafer, and the contact angle was measured 10 seconds after dropping. The results are shown in Table 2.

### Preparation of Surface Treatment Agent and Confirmation of Hydrophobization Results (Examples 17 to 19 and Comparative Example 13)

Surface treatment agents of solvent type (type containing solvent) were produced as Examples 17 to 19 by causing 10% by mass of the surface treatment agent of Example 1 to dissolve in every solvent listed in Table 3. In addition, a surface treatment agent of solvent type was produced as Comparative Example 13 by causing 10% by mass of the surface treatment agent of Comparative Example 1 to dissolve in cyclohexanone.

After a silicon wafer had been immersed for 30 seconds at room temperature in the surface treatment agents of Examples 17 to 19 and Comparative Example 13 thus produced, the surface of this silicon wafer was cleaned with methyl ethyl ketone, and made to dry by flowing nitrogen. Then, using a Dropmaster 700 (Kyowa Interface Science Co., Ltd.), a droplet of pure water (1.8 μL) was dropped on the surface of this silicon wafer, and the contact angle was measured 10 seconds after dropping. The results are shown in Table 3.

TABLE 3

| | Surface Treatment | | Contact angle |
|---|---|---|---|
| | Agent as Base | Solvent | (degrees) |
| Example 17 | Example 1 | Cyclohexanone | 90 |
| Example 18 | Example 1 | PGMEA | 91 |
| Example 19 | Example 1 | n-Heptane | 90 |
| Comparative | Comparative | Cyclohexanone | 56 |
| Example 13 | Example 1 | | |

PGMEA: Propylene glycol monomethyl ether acetate

As shown in Table 1, it was found that, if surface treatment was performed using the surface treatment agents of Examples 1 to 7 containing the silylation agent and the silylated heterocyclic compound (trimethylsilyl imidazole), the contact angle to water of the wafer having received surface treatment will be larger than the case of having performed surface treatment using the surface treatment agents of Comparative Examples 1 to 7, which do not contain a silylated heterocyclic compound, irrespective of having used the same type of silylation agent. In addition, from comparison of Example 10 and Comparative Example 1, it was found that such results were obtained also in the case of having used trimethylsilyl triazole as the silylated heterocyclic compound. From these facts, it was understood that, by the surface treatment agent containing a silylated heterocyclic compound, surface treatment is promoted by the silylation agent and the hydrophobicity of the surface of the substrate is increased. Therefore, it was found that the hydrophobization effect on the surface of the substrate increased by containing a silylated heterocyclic compound in addition to a silylation agent in the surface treatment agent to perform silylation on the surface of the substrate.

In addition, comparing the contact angle to water in a case of having performed surface treatment with the surface treatment agent of Example 2 and the contact angle to water in a case of having performed surface treatment with the surface treatment agents of Examples 8 and 9, it was found that the contact angle to water of the substrate to which surface treatment had been performed is increased by setting the substituent contained in the silyl group of the silylation agent to be a large (bulky) group. Therefore, it was found that, when using a silylation agent having a bulky substituent in the surface treatment agent to perform silylation on the surface of a substrate, the hydrophobization effect on the surface of the substrate becomes greater.

In addition, comparing Examples 12, 13, 15 and 16 with Example 1, it was found that the contact angle on the substrate becomes large by jointly using a silylation agent having a bulky substituent in the HMDS (silylation agent). Additionally, it was found that, even in a case of silylating the surface of a silicon nitride substrate, the hydrophobization effect on the surface of the substrate increases by having a silylated heterocyclic compound contained in the surface treatment agent, similarly to the case of silylating a silicon substrate, as shown in Table 2.

Furthermore, it is understood that the above-mentioned results were similarly obtained also with the surface treatment agent of solvent type, as shown in Table 3.

What is claimed is:

1. A surface treatment agent used in surface treatment of a substrate, comprising a silylation agent and a silylated heterocyclic compound.

2. A surface treatment agent according to claim 1, wherein the silylation heterocyclic compound is a silylated nitrogen-containing heterocyclic compound.

3. A surface treatment agent according to claim 1, wherein a heterocyclic ring contained in the silylated heterocyclic compound has aromaticity.

4. A surface treatment agent according to claim 1, wherein the silylated heterocyclic compound is at least one selected from the group consisting of a silylated imidazole compound and a silylated triazole compound.

5. A surface treatment agent according to claim 1, wherein the silylated heterocyclic compound is represented by the following general formula (1), 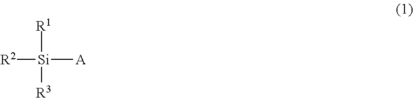
wherein R¹, R² and R³ each independently represent a hydrogen atom or organic group, and at least one among R¹, R² and R³ represents an organic group; and A represents a substituted or unsubstituted heterocyclic group contained in the silylated heterocyclic compound.

6. A surface treatment agent according to claim 1, wherein the silylation agent is represented by the following general formula (2), 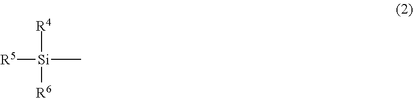
wherein R⁴, R⁵ and R⁶ each independently represent a hydrogen atom or an organic group, and a total number of carbon atoms contained in R⁴, R⁵ and R⁶ is at least 1.

7. A surface treatment agent according to claim 6, wherein the total number of carbon atoms contained in R⁴, R⁵ and R⁶ is at least 4.

8. A surface treatment agent according to claim 6, wherein any one of R⁴, R⁵ and R⁶ is an organic group having at least 2 carbon atoms, and two remaining of R⁴, R⁵ and R⁶ each independently is a methyl group or ethyl group.

9. A surface treatment agent according to claim 1, further comprising a solvent.

10. A surface treatment agent according to claim 1, wherein the surface treatment is a treatment on a surface of an inorganic pattern or resin pattern provided on a substrate.

11. A surface treatment method, comprising:
exposing a surface of a substrate to a surface treatment agent according to claim 1; and
treating the surface of the substrate.
